(19) United States
(12) Patent Application Publication
(10) Pub. No.: US 2003/0197347 A1
(43) Pub. Date: Oct. 23, 2003

(54) Terminello trailer

(76) Inventor: Leo Frank Terminello, Miami, FL (US)

Correspondence Address: LEO TERMINELLO, 1551 NE MIAMI GARDENS DR. #318, MIAMI, FL, 33179, US

(21) Appl. No.: 10/126,645

(22) Filed: Apr. 19, 2002

(51) Int. Cl. B60P 3/10

(52) U.S. Cl. 280/414.1

(57) ABSTRACT

This invention is a new concept in vehicular trailer load carrying, deployment and retrieval. This invention's simple design encompasses all vehicular trailers that carry, deploy and retrieve loads to the ground or water.

This trailer is not easily distinguishable from the present state of the art vehicular trailers at first glance; however it effectively resolves many of the problems with the present art's restrictive designs, initial price and maintenance costs.

### BACKGROUND OF THE INVENTION

1. The “Terminello Trailer” effectively addresses many of the inadequacies of the present art of vehicular trailers. A new system, simple in concept, of vehicular trailer load carrying, deployment and retrieval. It encompasses anything that is transported by a vehicular trailer and put to the ground or water and retrieved. This system would allow a load to be deployed over a precipice of considerable depth. The “Terminello Trailer” is readily adaptable for carrying boats, automobiles, trucks, construction equipment, farm equipment, military equipment and rescue equipment.

2. The boat trailer embodiment of this system allows boats to be launched where no launching ramp or facility is available or would be arbitrarily avoided. In a typical boat launching ramp or facility scenario, the fee for using the ramp or facility will be eliminated. This invention will negate the need to get running gear and lights wet, a major source of expense and tribulation.

3. In the vehicle carrying embodiment the simplicity of the “Terminello Trailer” system will make hydraulic apparatus for operation unnecessary, an immense saving in manufacturing and maintenance costs.

### BRIEF SUMMARY OF THE INVENTION

1. The inventive longitudinal frame rail guide is the key to the functioning of this invention. In executing deployment or retrieval of any load of a vehicular trailer this guide when unlocked from the main frame detaches the suspension from the main frame rails and allows the main frame to slide forward or aft in relation to the suspension in order to deploy or retrieve loads carried on any vehicular trailer.

2. In conjunction with the inventive longitudinal frame rail guide a pre-determined relative height of the hitch on the towing vehicle to that of the height of the trailer axle, the moving of the towing vehicle actuates the dynamic changes that result from the sliding of the frame rails in the inventive frame rail guides.

### BRIEF DESCRIPTION OF THE SEVERAL VIEWS OF THE DRAWING

The drawings furnished herewith illustrate a preferred construction of the present invention in which the above advantages and features are clearly disclosed as well as others which will be readily understood from the following description of the illustrated embodiment.

In the drawings:

FIG. 1 is an isometric view of the boat trailer embodiment of the “Terminello Trailer” system in accordance with the present invention;

FIG. 2 is a two dimensional view from above of the inventive longitudinal rail guide with an open channel on the top and shown with the inventive, removable, and adjustable, spring-biased locking bolts,

FIG. 3 is an isometric view of the inventive longitudinal rail guide

FIG. 4 is an enlarged isometric view of the inventive, removable, and adjustable, spring-biased locking bolts,

FIG. 5 is an isometric view of an inventive trailer hitch assembly shown with the inventive, removable, and adjustable, spring-biased locking bolts,

FIG. 6 is a longitudinal view of the boat trailer embodiment in three stages of the loading/unloading procedure over a precipice and into water;

FIG. 7 is a longitudinal view of the boat trailer embodiment in three stages of the loading/unloading procedure at a typical boat launching ramp or facility.

FIG. 8 is a longitudinal view of the wheeled vehicle trailer embodiment and a tracked vehicle trailer embodiment in two stages each of the loading or unloading procedure on flat ground. Deployment over a precipice is possible.

### DETAILED DESCRIPTION OF THE PREFERRED EMBODIMENT

1. The strength of this invention is to be determined by the load to be carried and the terrain involved. Obviously a much sturdier construction of the “Terminello Trailer” would be required for a tank as opposed to a pleasure boat. However the principles herein apply to both ends of said gamut.

2. It is contemplated as being within the scope of the “Terminello Trailer” invention to be disclosed as a boat trailer, a wheeled vehicle trailer, a tracked vehicle trailer (such as tanks, construction equipment) a complete system for all motor vehicle trailer cargo carrying, deployment and retrieval.

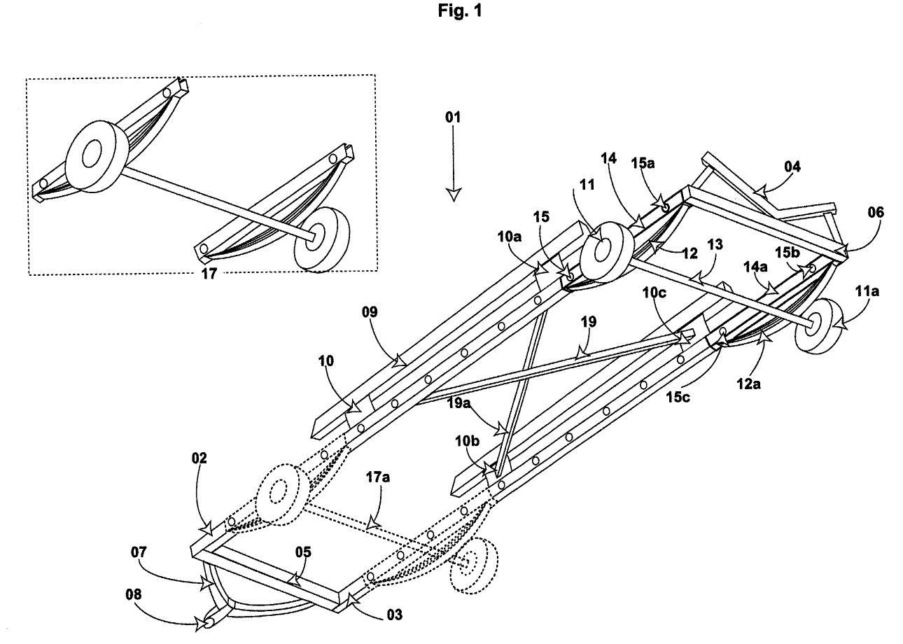

In Reference to FIG. 1:

1. A boat trailer embodiment is disclosed in accordance with the present invention and is generally designated by the numeral (01). (01) is a frame structure extending along a longitudinal axis including first and second side portions (02, 03) joined at the forward and aft ends with cross members (05, 06) to form a rectangular frame. (04, 09, 09a) are generic boat supports. (19, 19a) are diagonal braces thereof. Many configurations of the supports are conceived, the description of such would be extensive and beyond the scope of this application.

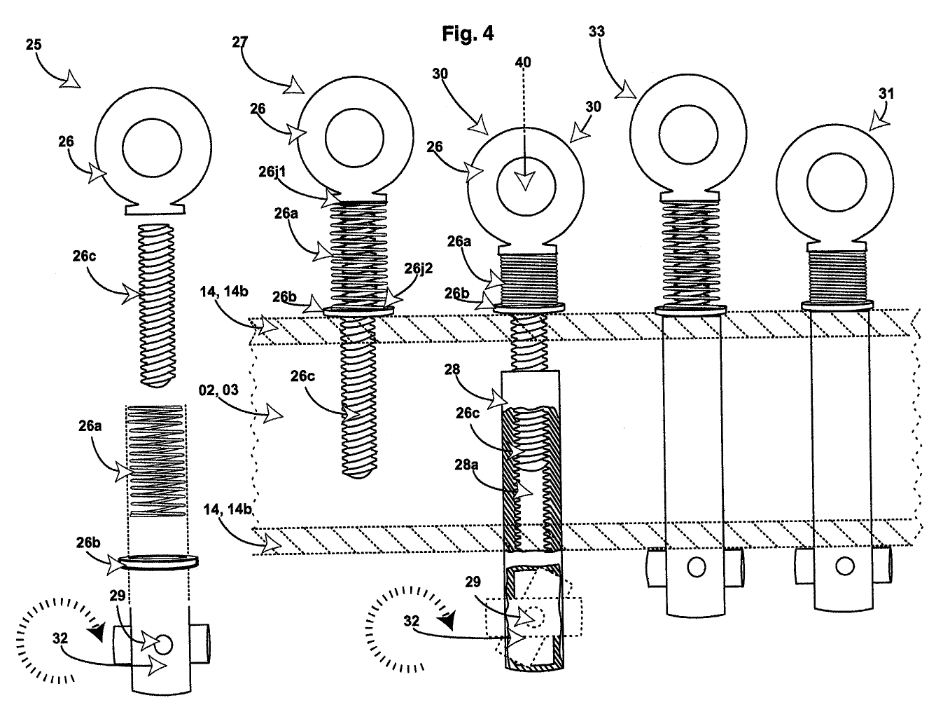

2. Also included in (01) is a yoke (07) at the forward end where is attached a cup shaped receiver (08) mounted thereon for connecting to the dedicated inventive trailer hitch assembly not shown here and described in detail in (FIG. 04) or generic equivalents thereof.

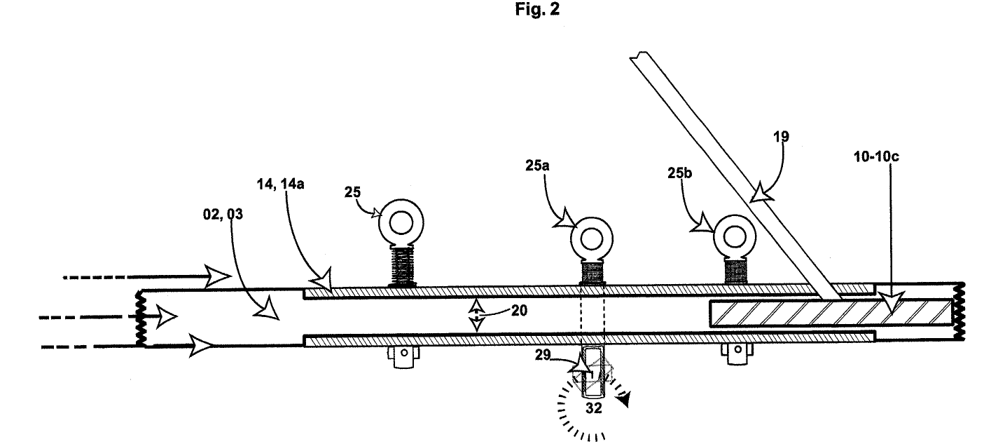

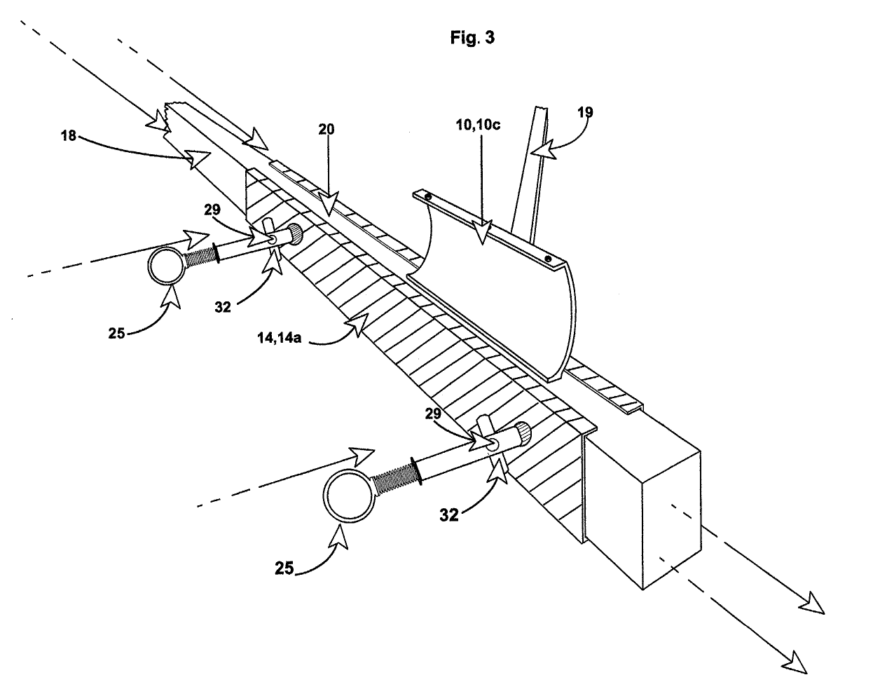

3. Two inventive longitudinal rail guides (14, 14a), one on each of the two longitudinal frame rails (02, 03), with open channels at the top of each [(20) (FIG. 2); (20) FIG. 3] with through passages (orifices), (15, 15a, 15b, 15c,) generally designated as (15), through the corresponding passages in the main frame rails (02, 03) to accept the inventive, removable, and adjustable, spring-biased locking bolts, or generic equivalent thereof, [(25) FIG. 4,] or other generic equivalent attaching devices that secure or release the side portions (02, 03) to either pass through said rail guides or be secured.

4. A generic wheel (11, 11a)/leaf spring (12, 12a)/axle (13) assembly is shown. (11, 11a, 12, 12a, 13, 14, 14a, 15, 15a, 15b, 15c) is permanently attached to inventive longitudinal rail guides (14, 14a).

5. The complete suspension system will be generally designated as (17) and is shown as such separately and encompasses (11, 11a, 12, 12a, 13, 14, 14a, 15, 15a, 15b, 15c). (17a) discloses the extreme forward position of (17). The components in (01) other than (17) are generally designated as (18).

In Reference to FIG. 2:

1. The inventive longitudinal rail guide [(14), (14a) FIG. 1] is disclosed in a two dimensional view from above. The channel (20) on the top is shown. Load supports (10), (10c) are shown in the channel of [(14), (14a) FIG. 1] with a diagonal brace (19).

2. The suspension [(17) FIG. 1] is released or secured in relation to the main frame assembly [(18) FIG. 1] to allow the main frame rails [(02), (03) FIG. 1] to pass through the inventive longitudinal rail guides [(14, 14a) FIG. 1].

3. Releasing and securing is accomplished by depressing the inventive, removable, and adjustable, spring-biased locking bolts; (25), disclosed in [(25) FIG. 4)] allowing clearance for the locking rod (32) to be rotated on the axis of the retainer pin (29). (25b) discloses [(25) FIG. 4)] in the locked position. Other generic equivalent devices may be incorporated.

In Reference to FIG. 3:

1. The inventive longitudinal rail guide [(14), (14a) FIG. 1] is disclosed in an isometric view from above.

2. The open channel (20) on the top is shown. One of the several load supports (10)-(10c) with permanently attached diagonal braces (19) is shown in the channel of [(14), (14a) FIG. 1] and are permanently attached to the top of each of the two main frame side portions [(2, 3) FIG. 1].

3. The suspension [(17) FIG. 1] is released or secured in relation to the main frame assembly [(18) FIG. 1] to allow the main frame side portions [(02), (03) FIG. 1] to pass or not pass through the inventive longitudinal rail guides [(14, 14a) FIG. 1].

4. Releasing and securing is accomplished by depressing the inventive, removable, and adjustable, spring-biased locking bolts; (25) [(25) FIG. 4)] (32)], or generic equivalent thereof, causing the end thereof to extend beyond the width of the inventive longitudinal rail guides and main frame side portions [(02, 03) FIG. 1] to allow the locking rod (32) to be rotated on the axis of the retainer pin (29) to attach or detach the inventive, removable, and adjustable, spring-biased locking bolts, or generic equivalents thereof.

In Reference to FIG. 4

1. The inventive, removable, and adjustable, spring-biased locking bolt, (25) is disclosed. (26) is the adjustable handle. (26a) is the spring. (26b) is the retainer. (26c) is the threaded rod which is screwed into the tapped orifice (28a) in (28) to an adjustable depth therein.

2. (26), (26a), (26b), (26c) are permanently joined as shown in (27) as follows: (26) is permanently attached to (26a) and (26c) at (26j1). (26a) is permanently attached to (26b) at (26j2).

3. (30) illustrates that (26b) being attached only to (26a) at (26j2) allows the bolt main body (28) to extend and retract through the passages [(15) FIG. 1] to clear the outside of (14), (14b). Depressing the adjustable handle (40) compresses the spring (26a) to allow the locking rod (32) to be rotated on the axis of the retainer pin (29) to attach or detach (25) from the main frame [(02, 03)FIG. 1] and rail guides [(14), (14b)FIG. 1].

4. (33) Discloses (25) in the spring (26a) compression released position. The frame side portions [(02, 03) FIG. 1] and the inventive longitudinal guides [(14), (14b) FIG. 1] secured and not locked,

5. (31) Discloses (25) with the spring compressed by turning (26) into (28a) locking (25), [(02, 03) FIG. 1] and [(14), (14b) FIG. 1].

6. The faculty of (25) for adjustment assures an accurate closure thereof.

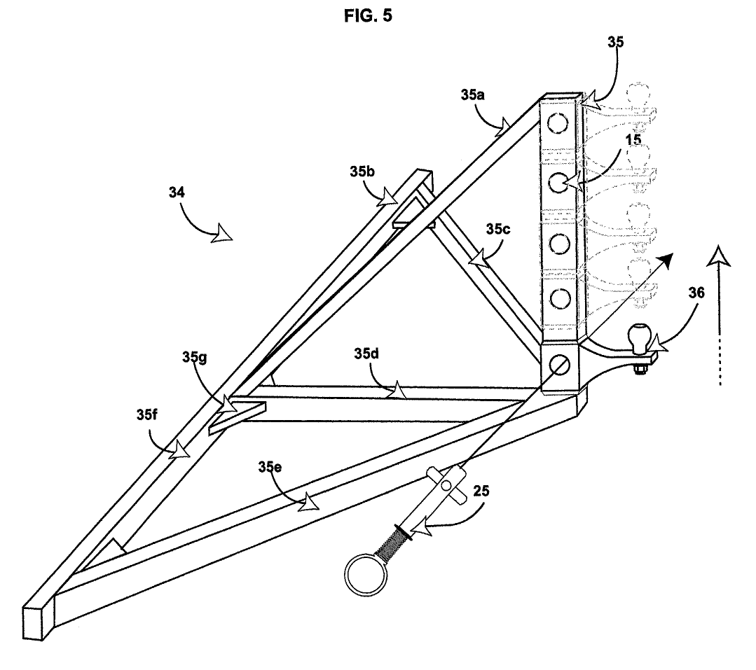

In Reference to FIG. 5

1. Disclosed is an isometric view of the inventive adjustable hitch embodying a vertical frame member (35) with several passages (15) for the insertion of the inventive, removable, and adjustable, spring-biased locking bolts,; (25) [(25) FIG. 4)] or generic equivalent thereof, through the several passages provided in (35) and (36) to adjust the height of the adjustable inventive trailer-hitch ball bracket with a generic ball hitch (36), and supported by a horizontal A-frame structure and stiffened by diagonal supports and gussets (35)-(35f) and is generally designated as (34).

2. It is conceived that (34) must be adapted to the particular towing vehicle and an infinite number of trailer applications so as to facilitate the many conceived embodiments of this invention. Other height adjustable hitches may be incorporated

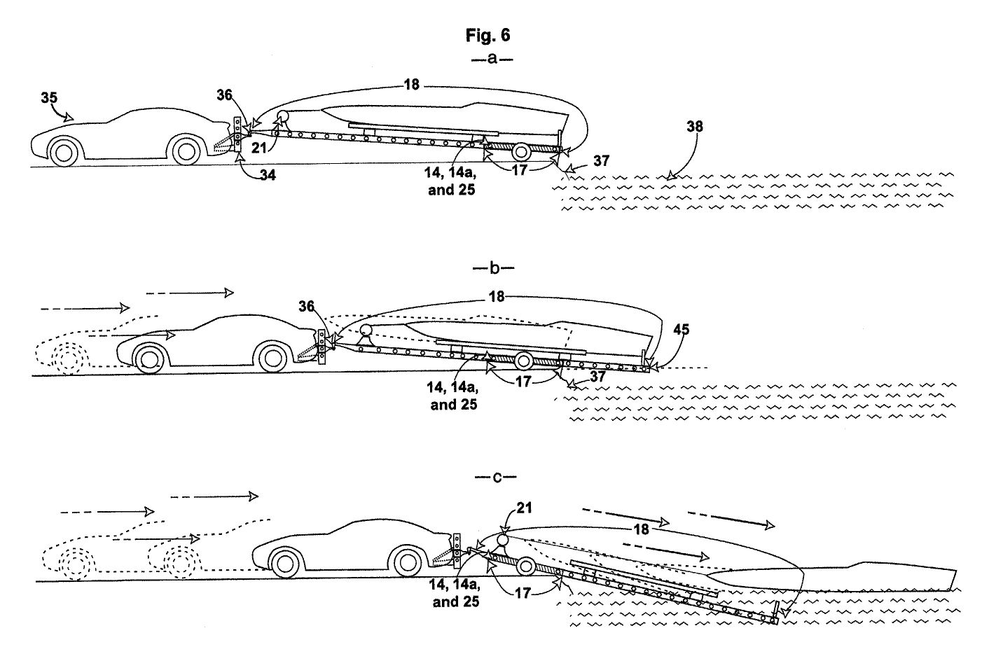

In Reference to FIG. 6

1. Here is disclosed the boat trailer embodiment of the “Terminello Trailer”. Three stages of operation without a boat launching ramp or facility, over a precipice (37) and into water (38) are shown in three separate stages of deployment, (a), (b), and (c). In all three stages (17) is shown positioned at the extreme end of (18). This positioning capability of the “Terminello Trailer” system makes it possible to place (17) in the optimal position relative to (18) for weight distribution in cartage, as well as flexibility in deployment and retrieval.

2. In all three stages the height of the trailer axle (17) is lower than the hitch (36) of the towing vehicle. The inventive trailer hitch assembly [(34) FIG. 3], or generic equivalent thereof, is designed to achieve the correct relative height of the inventive trailer hitch ball bracket (36) to the trailer axle (17

3. In (a) the wheel brake is set (not shown) or the wheels chocked in place, (not shown), the inventive, removable, and adjustable, spring-biased locking bolts;[(25) FIG. 4)], or generic equivalent thereof, are removed and should be stored in empty passages on the assembly for safe keeping. Thus the load may be placed at the destination simply by driving the towing vehicle (35) aft.

3. The intermediate position is disclosed in (b) wherein when the towing vehicle is moved, in this case aft, a pre-determined relative height of the hitch (36) on the towing vehicle to that of the height of the trailer axle assembly (17) in conjunction with the inventive longitudinal frame rail guide [FIG. 1. (14, 14a) effect the dynamics thereof causing the rear end of the trailer to go down (45) ultimately to the destination point, be it water (38), the ground or until a point is reached that is satisfactory for deployment. The rate of change is determined by the difference in the height of the trailer hitch (36) to the trailer axle (17).

4. In (c) the boat launching into water (38) is accomplished. The winch cable (21) may be slowly unwound from the reel in some cases, or the load may simply slide off the load supports [(10, 10a, 10b, 10c) FIG. 1]. In this and other embodiments generic rollers and similar generic devices may be incorporated.

5. The reverse of the foregoing procedure is used for retrieval of the load, in this embodiment, a boat.

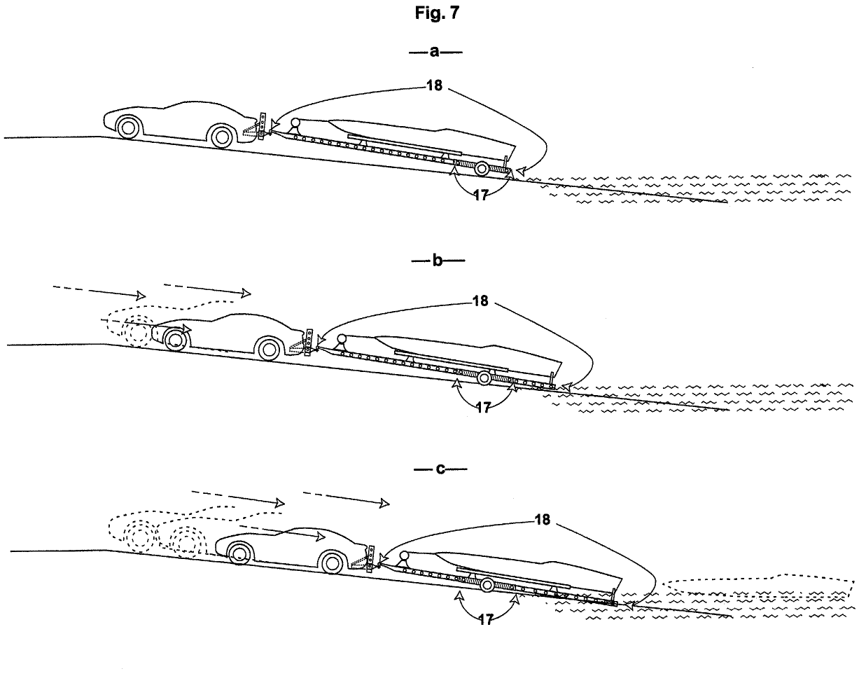

In Reference to FIG. 7

FIG. 7 discloses the boat trailer embodiment of FIG. 6. in accordance with the present invention operated at a typical boat launching ramp or facility. All of what is contained in FIG. 5 and FIG. 6 applies to FIG. 7 plus the capability of this invention of not submerging the trailer axle assembly or electrical components (17) at the aforementioned typical boat launching ramp or facility is demonstrated

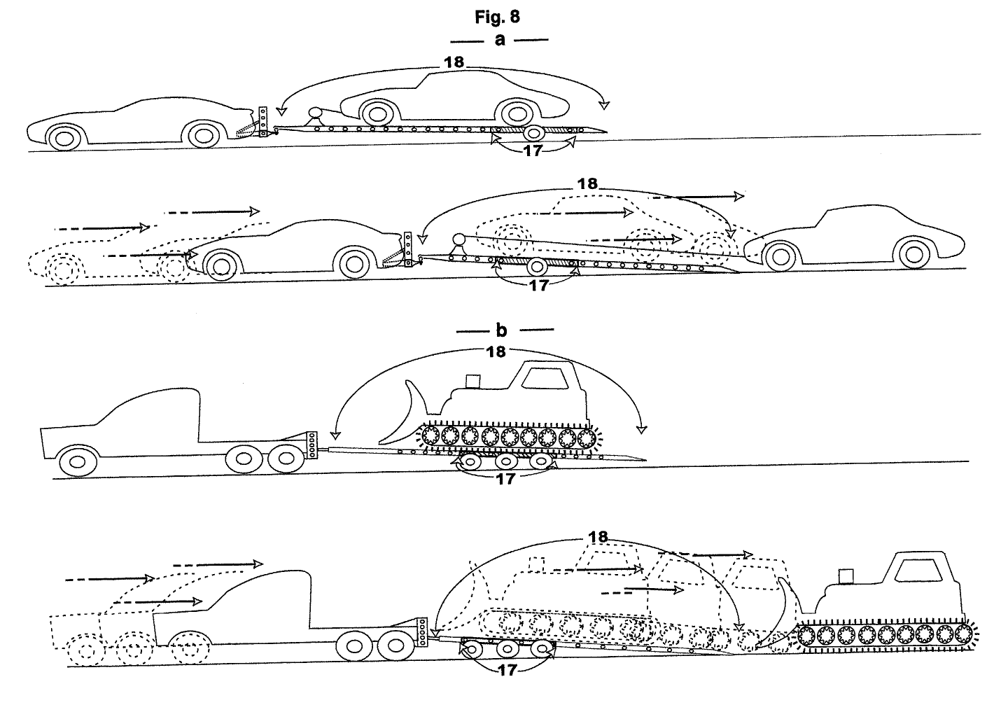

In Reference to FIG. 8

Two additional embodiments are disclosed.

1. (a) s an automobile embodiment. the loading and unloading procedure is essentially the same as in FIG. 5 including deployment over a precipice, not shown in this rendering.

2. (b) Is a construction vehicle embodiment, in this case a bulldozer, a broad range of configurations are contemplated.

3. Various modes of carrying out the invention are contemplated as being within the scope of the following claims particularly pointing out and distinctly claiming the subject matter which is regarded as the invention

What I claim as my invention is:

1. A load carrying vehicular trailer comprising:
(a) a generic frame structure extending along a longitudinal axis; the frame structure including first and second side portions and at least first and second cross frame members transverse to the longitudinal axis and inter-connected at the front and rear to the side portions. A broad range of generic load supports are contemplated to be attached to the frame side portions.
(b) A generic suspension with at least two wheels, at least one axle and at least two semi-elliptical or other spring assemblies extending along an axle axis transverse to the longitudinal axis of the frame structure.
(c) At least two inventive longitudinal rail guides permanently attached to (b) comprised of: 1. a larger diameter than that of the frame side portions so as to closely surround the side portions of the frame structure with sufficient clearance for movement of the frame side portions within. 2. An open channel at the top to allow the above load supports with diagonal members attached thereto to pass through. 3. Several through passages or orifices for insertion of the inventive, removable, and adjustable, spring-biased locking bolts of claim 2, or generic equivalents thereof..
(d) This invention operates to accommodate a broad range of the imperatives of deployment, retrieval or positioning for cartage described in the following scenario: 1. the relatively higher from the ground position of the towing vehicle's hitch to that of the lower height of the axle of the suspension system of the trailer from the ground; 2. moving the towing vehicle with the trailer suspension system secured from moving; 3. the load supports pass through the inventive longitudinal frame guides, when the inventive, removable and adjustable spring-biased locking bolts of claim 2, or the equivalent thereof, are removed.

2. The trailer of claim 1 wherein said invention further comprises the inventive, removable, and adjustable, spring-biased locking bolt, that operates by being compressed causing
(a) the end thereof to extend beyond the width of the frame and frame guides allowing the locking rod thereof to be rotated to either attach or detach the bolt and releasing the compression to either attach or detach the bolt.
(b) The inventive, removable, and adjustable, spring-biased locking bolt, assembly may be locked to increase the security thereof by and after insertion into the several passages or orifices and rotating the locking rod to the secured position that is parallel to the inventive longitudinal frame guide, releasing the compression thereon and the handle of the bolt is turned to close the diameter of the bolt assembly in relation to the width of the frame and frame guides whereby the spring is collapsed and the locking rod is adjacent to the outside of the frame assemblies
(c) The adjustability of the inventive, removable, and adjustable, spring-biased locking bolt, insures an accurate and secure fit.

3. The trailer of claim 1. wherein the invention further comprises an inventive vehicle hitch assembly with
(a) an inventive adjustable trailer hitch ball bracket capable of height adjustments implemented by the appropriate positioning of the inventive trailer hitch ball bracket with the aid of a generic trailer jack.
(b) The adjustments are made upon the vertical section with several passages therein for the inventive, removable, and adjustable, spring-biased locking bolts of claim 2, or generic equivalents thereof to attach, detach or adjust the components in relation to each other.
From the foregoing, it will be seen that this invention is one well adapted to attain all of the ends and objects hereinabove set froth, together with other advantages which are obvious and which are inherent to the tool.
